(19) United States
(12) Patent Application Publication
(10) Pub. No.: US 2004/0249947 A1
(43) Pub. Date: Dec. 9, 2004

(54) Concurrent cluster environment

(75) Inventors: Reynaldo Novaes, Novo Hamburgo (BR); Roque Scheer, Porto Alegre (BR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/443,079

(22) Filed: May 22, 2003

(51) Int. Cl. G06F 15/173

(52) U.S. Cl. 709/226; 718/100

(57) ABSTRACT

The invention relates to method and apparatus for running a plurality of interrelated computational tasks on a plurality of host computers. The host computers run a primary operating system. The method includes the steps of: establishing a virtual machine running on a host computer where the virtual machine is configured to run as a native application emulating a secondary operating system including storage and I/O functionality. The virtual machine may be configured to provide the host computers primary operating system with access to the virtual machines secondary operating system and the virtual machine with access to the host computers system resources. The virtual machine may also emulate a file system by providing a guest file system and provide access to the host computers system resources via a host system call converter. Virtual machine system calls are converted to the host systems system calls by a host system call converter and controls the access to the users system resources. The host system call converter also provides access to the guest file system.

### TECHNICAL FIELD

The present invention relates to methods and apparatus for carrying out distributed computational tasks. More particularly, although not exclusively, the invention relates to methods and apparatus for exploiting idle time on a plurality of computers in a distributed, possibly clustered, environment in a manner which is secure and transparent to the user.

### BACKGROUND ART

The development and commoditisation of relatively powerful computers combined with stable and fast network technologies has led to the realisation that the computing power of many machines lies largely underutilised for a substantial portion of the time. This is particularly so in the case of current single-user desktop computers which are connected to a network. Such machines are generally idle during the night and during periods when the user is not directly interacting with the machine. In particular, computers generally have sufficient power to provide extremely fast response times for standard applications such as word-processing, calculations or web-page rendering. However, in reality, most of the time, the processing power of the computer is unused as the machine sits idle waiting for user requests.

During such periods, which can range from fractions of a second to hours or days, the operating system normally executes a dummy process called “idle” which has a low execution priority. This process runs only when there are no other processes being executed. Thus the computers processing power is being wasted while the idle process is being executed.

Concurrent cluster environments and other forms of distributed processing techniques aim to exploit computer idle-time by splitting up very large computational tasks into discrete parts, or tasks, and distributing these tasks for execution on many computers. These tasks can then be run as standalone applications with a specified priority.

An example of such a technique is the SETI@home project which is concerned with numerical analysis of radio telescope signal data. Analysing such data is a computationally extremely intensive task as it involves finding candidate signals in a time-varying power spectrum filled with noise, man-made signals and periodic signals unrelated to candidate extraterrestrial signals. Individual users volunteer the idle time of their computers by subscribing to SETI@home and download an application that, from the users point of view, operates like a screensaver. However, the screensaver functions so that during the PCs idle time, a platform-dependant application analyses a “chunk” of power spectrum data which is downloaded when the screensaver is initially installed. When the user interrupts the screensaver, for example to routinely use the computer, the state of the calculation is saved until the next screensaver timeout period whereupon the task is reloaded in its previous state and the calculation continues. When the task is completed and the “chunk” analysed, the program waits until the user is connected to the internet whereupon the completed calculation result is uploaded to a coordinating server and a new task is downloaded. The server manages the completed tasks and keeps track of which user is dealing with a specific chunk of data.

The reader is referred to SETI@home: An Experiment in Public-Resource Computing, Communications of the ACM, Vol. 45 No. 11, November 2002, pp. 56-61 for further details. As of November 2002 computation has performed 1.7e21 floating point operations, representing the largest computation ever made.

While representing a very effective method of distributing a complex computing task over a large number of computers, the SETI@home system runs as a native, operating system dependant application. For example, the application runs as a Windows, DOS or unix program and can be thought of as a type of load-dependant task-switching system. Such an arrangement can also be envisaged as an ad hoc cluster environment which is constituted by the machines which are executing the tasks at any given instant. Thus, in effect, the cluster behaves as a low-cost supercomputer making only minimal demands on the day to day operation of the constituent machines.

Other examples of this type of idle-time utilisation systems include molecular modelling and statistical calculations. As noted above, the tasks can be native applications running under a specified operating system. However, a possible alternative to this type of task-focussed native application are Java virtual machines. Distributed virtual machines execute interpreted intermediate code running on each computer. However, this technique is not ideal as there is a performance overhead resulting from the translation from the intermediary code to native instructions and further restricts the flexibility of the application developer in choosing a programming language and tools. A further problem with Java virtual machines in this context is that it is not possible to emulate all of the physical devices present on the host machine.

One problem with any such system of this type is that of security as each distributed application runs as a normal program or service inside the users environment.

Another method for utilising PC idle time is configuring a group of PCs as dedicated cluster nodes when they are in an idle state. This approach usually requires a separate partition to store the cluster node environment and the PC must be rebooted to switch to the cluster runtime environment. Although this avoids the perceived security risk for the native application situation, this is not ideal as reboot times are not insignificant and thus the switch into cluster mode should occur only when there is a period of idle time sufficiently long to justify the time-consuming operation. Further, actually detecting a machines true idle state may not be completely reliable. In this situation, the user or system must somehow detect a real idle-time context to avoid rebooting when a user is, for example, downloading a file, running a lengthy non-interactive application or carrying out a similar operation which superficially makes the machine appear as if it is idle.

The PC does not need to be completely idle to exploit its processing power. The user could offer his computer for shared or cluster use even when he is using it. In this situation, the distributed task can be allowed to run as a background process while the user continues to use the computer.

It is an object of the present invention to provide a method and apparatus which deals with these issues and provides a concurrent cluster environment which is secure, transparent to the user and easily and quickly invoked when an idle state is detected. It is a further object of the invention to provide a task-focussed application technique which is robust, flexible and allows complete emulation of the native o/s environment.

### DISCLOSURE OF THE INVENTION

In one aspect, the invention provides a method of running a plurality of interrelated computational tasks on a plurality of host computers, running a primary operating system, comprising the steps of: establishing a virtual machine running on a host computer; the virtual machine configured to run as a native application emulating a secondary operating system including storage and i/o functionality.

The virtual machine is configured to provide the host computers primary operating system with access to the virtual machines secondary operating system and the virtual machine with access to the host computers system resources.

Preferably, the virtual machine emulates a file system by providing a guest file system.

In a preferred embodiment the virtual machine provides access to the host computers system resources via a host system call converter. This abstraction layer converts the virtual machine system calls to the host systems system calls and controls the access to the users system resources.

The host system call converter also provides access to the guest file system.

The method also includes the step of running one or more cluster applications in the virtual machines address space wherein the cluster applications run as native virtual machine applications thereby requiring no recompilation to take into account the host machines runtime environment.

Preferably, the virtual machine and the cluster applications running on it, have a low runtime priority setting compared to normal user applications thereby minimising their interference with the normal user-based operation of the host computer.

In one embodiment the virtual machine(s) can be configured to emulate one or more of the physical devices present on the host system.

Preferably the virtual machine and the cluster applications running on it constitute a cluster environment, the state of which is automatically maintained by the host computer primary operating system so the cluster environment is able to be executed whenever a trigger condition occurs.

Preferably the trigger condition corresponds to the host computer being idle. Alternatively, the trigger condition can correspond to a specified user operation including configuring the host computer to execute the cluster environment when specific conditions are met.

In an alternative embodiment, the execution of the cluster environment may be controlled at will by the user.

In a further aspect, the invention provides a network of computers configured to operate in accordance with the method as hereinbefore defined.

In a further aspect, the invention provides for a computer cluster configured to operate in accordance with the method as hereinbefore defined.

In a further aspect, the invention provides a computer programmed as a host computer configured to execute the cluster environment as hereinbefore defined.

### BRIEF DESCRIPTION OF THE DRAWINGS

The present invention will now be described by way of example only and with reference to the drawings in which:

FIG. 1: illustrates a schematic showing the abstraction layers in one embodiment of a concurrent cluster environment;

### BEST MODE FOR CARRYING OUT THE INVENTION

The following description of an exemplary embodiment will be given in the context of a cluster of computers running a windows-based operating system and connected by means of a TCP/IP or similar network. However, it is noted that other hardware architectures and operating system environments may be suitable for implementation of the present invention.

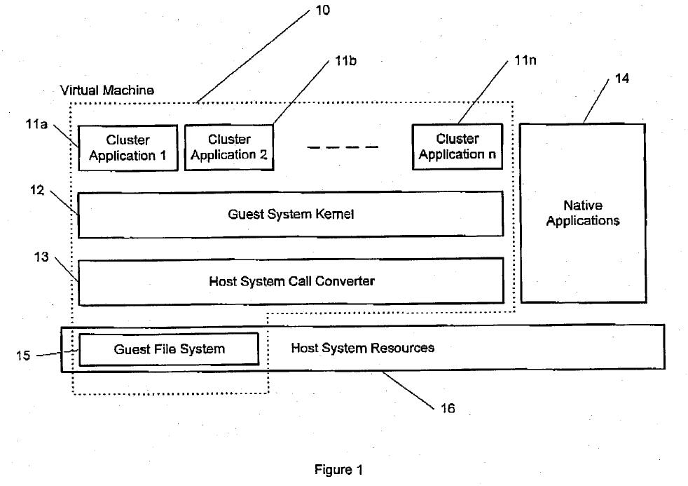

Referring to FIG. 1, a schematic showing the abstraction layers for the present invention is shown. A plurality of interrelated computational tasks, or cluster applications 11a, 11b . . . 11n is shown running in the virtual machine 10. Each virtual machine is run on a plurality of host computers (not shown), running a primary operating system and including host systems resources 16. Once the virtual machine 10 is running on the host computer, it is configured to run as a native application and from the computers point of view is equivalent to the machines ‘normal’ native applications 14.

The virtual machine 10 emulates a secondary operating system including a guest system kernel 12, a host system call converter 13, storage and i/o functionality. The virtual machine can also be configured, for example by multiplexing, to emulate all of the physical devices present on the host system.

The virtual machine 10 is thus configured to provide the host computers primary operating system with access to the virtual machines secondary operating system as well as the virtual machine with access to the host computers system resources 16.

The virtual machine may emulate a file system by providing a guest file system 15. This is constituted by part of the virtual machine but is effectively part of the host system resources 16.

The virtual machine 10 provides access to the host computers system resources 16 via a host system call converter 13. This abstraction layer 13 converts the virtual machine system calls to the host systems system calls and controls the access to the users system resources 16 and provides access to the guest file system 15.

One or more cluster applications 11a, 11b . . . 11n can be run in the virtual machines address space. As noted above, the cluster applications run as native virtual machine applications thereby requiring no recompilation to take into account the host machines runtime environment.

In operation, the virtual machine 10 and the cluster applications 11 running on it may be allocated a relatively low runtime priority setting compared to normal user applications. This minimises interference between the cluster applications and the normal user-based operation of the host computer.

The virtual machine 10 and the cluster applications 11 running on it can be thought of as constituting a cluster environment. The state of the cluster environment is automatically maintained in memory by the host computer primary operating system. Thus the cluster environment can be executed whenever a specified trigger condition occurs.

A trigger condition is the machine context which allows of initiates processing of the cluster applications. In one embodiment this may correspond to the host computer being idle for a minimum specified period of time. For example, such a context usually occurs at night for a normal desktop machine. Alternatively, the trigger condition can correspond to a specified user operation or function. This might include configuring the host computer to execute the cluster environment when specific conditions are met. Such conditions may include specifying a lower limit to the machines activity at which the cluster applications are allowed to run. This may be useful where the user of the machine is willing to devote CPU cycles to the cluster application(s) even while the computer is being used.

In this situation, the execution of the cluster environment may be controlled at will by the user or specified by a set of application parameters.

In practice, the invention may be implemented in a network or cluster of computers configured to operate in accordance with the method outlined above. For brevity, specifics of the cluster node administration will not be described in detail. This operation is within the purview of one skilled in the relevant technical field.

The invention provides particular utility in that the machines forming the cluster need not have the same operating system. The virtual machine needs to be compiled for the various operating systems. However, once this is done and the virtual machine software installed, the virtual machine(s) can be executed at will across a network of machines possibly having different operating systems, hardware architectures and processing power.

The invention provides a further significant advantage in that the cluster modules (i.e., the actual cluster applications) need only be written for the virtual machine runtime environment and not for every different operating system on which the virtual machine is to run. Once the runtime environment is fully specified, cluster applications can be written, tested and then distributed across the cluster to be run in a completely self-contained and secure environment.

The invention provides a number of further advantages including robust security. This is achieved by the virtual machine only having access to an emulated file-system that is stored as a normal file on the host machines file-system. Security is also enhanced as the virtual machine ensures isolation between the cluster applications running under it and the regular user applications running on the host machine. The virtual machine itself acts as a native application and runs concurrently with the other applications on the machine, sharing the systems resources with them. A further significant advantage is provided in that CPU intensive applications run at native machine speed since there is no machine instruction emulation. Cluster applications are loaded into the virtual machine address space and function as if they were running on a dedicated machine.

In a preferred embodiment, the virtual machine runs as a process having the second lowest priority on the system. That is, having a priority slightly higher than the operating systems idle process (or equivalent). This avoids the virtual machine interfering with normal use of the computer. Thus the operating system will execute the virtual machine only when there is no other process able to run and will execute it instead of the idle process. Thus the impact on the normal use of the computer is minimal and the user does not need to be even aware of the participation of his or her machine in the cluster. This operation may require disabling of screen-saver and other power-saving functions of the operating system, but this will vary between platforms and operating systems.

Other embodiments of the invention include adaptations to deal with large variations in the performance exhibited by different machines and concurrent usage by users. These variations can be taken into account in the administration of the cluster nodes as well as configuring the cluster application in the specified virtual machine environment. To this end, the cluster services, applications and the guest operating system running under the virtual machine may be configured to deal with long periods of suspension, timeouts and the like.

Other variants include confirmations adapted to handle various models of task distribution, load balancing, node performance, profiling, remote node management and the like. These factors may be tailored to the characteristics of the given concurrent cluster environment.

Although it is noted that the invention is amenable to application on a wide variety of hardware and operating systems, a low-cost variant may be particularly useful. To this end, a user-mode linux based embodiment is envisaged.

Although the invention has been described by way of example and with reference to particular embodiments it is to be understood that modifications and/or improvements may be made without departing from the scope of the appended claims.

Where in the foregoing description reference has been made to integers or elements having known equivalents, then such equivalents are herein incorporated as if individually set forth.

1. A method of naming a plurality of interrelated computational tasks on a plurality of host computers, rung a primary operating system, comprising the steps of: establishing a virtual machine running on a host computer; the virtual machine configured to run as a native application emulating a secondary operating system including storage and i/o functionality.

2. A method as claimed in claim 1 wherein the virtual machine is configured to provide the host computers primary operating system with access to the virtual machines secondary operating system and the virtual machine with access to the host computers system resources.

3. A method as claimed in any preceding claim wherein the virtual machine emulates a file system by providing a guest file system.

4. A method as claimed in any preceding claim wherein the virtual machine provides access to the host computers system resources via a host system call converter.

5. A method as claimed in claim 4 wherein the host system call converter converts the virtual machine system calls to the host systems system calls and controls the access to the users system resources.

6. A method as claimed in any preceding claim wherein the host system call converter also provides access to the guest file system.

7. A method as claimed in any preceding claim further including the step of running one or more cluster applications in the virtual machines address space wherein the cluster applications run as native virtual machine applications thereby requiring no recompilation to take into account the host machines runtime environment.

8. A method as claimed in any preceding claim wherein the virtual machine and the cluster applications running on it, have a low runtime priority setting compared to normal user applications thereby minimising their interference with the normal user-based operation of the host computer.

9. A method as claimed in any preceding claim wherein the virtual machine and the cluster applications running on it constitute a cluster environment, the state of which is automatically maintained by the host computer primary operating system so the cluster environment is able to be executed whenever a trigger condition occurs.

10. A method as claimed in claim 9 wherein the trigger condition corresponds to the host computer being idle.

11. A method as claimed in claim 9 wherein the trigger condition corresponds to a specified user operation including configuring the host computer to execute the cluster environment when specific conditions are met.

12. A method as claimed in any preceding claim wherein the execution of the cluster environment is controlled at will by the user.

13. A network of computers configured to operate in accordance with the method as claimed in any one of claims 1 to 12.

14. A computer cluster configured to operate in accordance with the method as claimed in any one of claims 1 to 12.

15. A computer programmed as a host computer configured to execute the cluster environment as claimed in any one of claims 1 to 12.
